(19) United States
(12) Patent Application Publication
(10) Pub. No.: US 2011/0308836 A1
(43) Pub. Date: Dec. 22, 2011

(54) INSULATION CONTAINING STYRENE COPOLYMERS

(75) Inventors: Jianmin LIU, Carmel, IN (US); Vijay MHETAR, Carmel, IN (US); James FREESTONE, Danville, IN (US)

(73) Assignee: General Cable Technologies Corporation, Highland Heights, KY (US)

(21) Appl. No.: 13/162,675

(22) Filed: Jun. 17, 2011

Related U.S. Application Data
(60) Provisional application No. 61/355,867, filed on Jun. 17, 2010.

(51) Int. Cl. H01B 3/30; H01R 43/00; C08K 5/3435; C08L 53/00; C08K 5/36

(52) U.S. Cl. 174/110 SR; 525/95; 524/505; 524/289; 524/102; 524/331; 524/303; 29/825

(57) ABSTRACT

The invention relates to cover compositions for electric power cables having a polyolefin and a styrene copolymer. The styrene copolymer 1) has a styrene content of 55 percent (by weight base on the total styrene copolymer) or greater; 2) contains a random arrangement of styrene and at least one other block polymer; and/or 3) contains a triblock having the formula S-AS-S, wherein S is styrene and A is alkylene or a mixture of different alkylenes. The cover can be an insulation or a jacket.

This application claims the priority of U.S. Provisional Patent Application Ser. No. 61/355,867, filed Jun. 17, 2010, which is incorporated herein by reference.

### FIELD OF THE INVENTION

The invention relates to cover (insulation or jacket) compositions for electric power cables having a polyolefin and a styrene copolymer. The styrene copolymer 1) has a styrene content of 55 percent (by weight base on the total styrene copolymer) or greater; 2) contains a random arrangement of styrene and at least one other block polymer; and/or 3) contains a triblock having the formula S-AS-S, wherein S is styrene and A is alkylene or a mixture of different alkylenes.

### BACKGROUND OF THE INVENTION

Typical power cables generally have one or more conductors in a core that is surrounded by several layers that can include: a first polymeric semiconducting shield layer, a polymeric insulating layer, a second polymeric semiconducting shield layer, a metallic tape shield and a polymeric jacket.

Polymeric materials have been utilized in the past as electrical insulating and semiconducting shield materials for power cables. In services or products requiring long-term performance of an electrical cable, such polymeric materials, in addition to having suitable dielectric properties, must be durable. For example, polymeric insulation utilized in building wire, electrical motor or machinery power wires, or underground power transmitting cables, must be durable for safety and economic necessities and practicalities.

One major type of failure that polymeric power cable insulation can undergo is the phenomenon known as treeing. Treeing generally progresses through a dielectric section under electrical stress so that, if visible, its path looks something like a tree. Treeing may occur and progress slowly by periodic partial discharge. It may also occur slowly in the presence of moisture without any partial discharge, or it may occur rapidly as the result of an impulse voltage. Trees may form at the site of a high electrical stress such as contaminants or voids in the body of the insulation-semiconductive screen interface. In solid organic dielectrics, treeing is the most likely mechanism of electrical failures which do not occur catastrophically, but rather appear to be the result of a more lengthy process. In the past, extending the service life of polymeric insulation has been achieved by modifying the polymeric materials by blending, grafting, or copolymerization of silane-based molecules or other additives so that either trees are initiated only at higher voltages than usual or grow more slowly once initiated.

There are two kinds of treeing known as electrical treeing and water treeing. Electrical treeing results from internal electrical discharges that decompose the dielectric. High voltage impulses can produce electrical trees. The damage, which results from the application of high alternating current voltages to the electrode/insulation interfaces, which can contain imperfections, is commercially significant. In this case, very high, localized stress gradients can exist and with sufficient time can lead to initiation and growth of trees. An example of this is a high voltage power cable or connector with a rough interface between the conductor or conductor shield and the primary insulator. The failure mechanism involves actual breakdown of the modular structure of the dielectric material, perhaps by electron bombardment. In the past much of the art has been concerned with the inhibition of electrical trees.

In contrast to electrical treeing, which results from internal electrical discharges that decompose the dielectric, water treeing is the deterioration of a solid dielectric material, which is simultaneously exposed to liquid or vapor and an electric field. Buried power cables are especially vulnerable to water treeing. Water trees initiate from sites of high electrical stress such as rough interfaces, protruding conductive points, voids, or imbedded contaminants, but at lower voltages than that required for electrical trees. In contrast to electrical trees, water trees have the following distinguishing characteristics; (a) the presence of water is essential for their growth; (b) no partial discharge is normally detected during their growth; (c) they can grow for years before reaching a size that may contribute to a breakdown; (d) although slow growing, they are initiated and grow in much lower electrical fields than those required for the development of electrical trees.

Electrical insulation applications are generally divided into low voltage insulation (less than 1 K volts), medium voltage insulation (ranging from 1 K volts to 69 K volts), and high voltage insulation (above 69 K volts). In low voltage applications, for example, electrical cables and applications in the automotive industry treeing is generally not a pervasive problem. For medium-voltage applications, electrical treeing is generally not a pervasive problem and is far less common than water treeing, which frequently is a problem. The most common polymeric insulators are made from either polyethylene homopolymers or ethylene-propylene elastomers, otherwise known as ethylene-propylene-rubber (EPR) or ethylene-propylene-diene ter-polymer (EPDM).

Polyethylene is generally used neat (without a filler) as an electrical insulation material. Polyethylenes have very good dielectric properties, especially dielectric constants and power factors. The dielectric constant of polyethylene is in the range of about 2.2 to 2.3. The power factor, which is a function of electrical energy dissipated and lost and should be as low as possible, is around 0.0002 at room temperature, a very desirable value. The mechanical properties of polyethylene polymers are also adequate for utilization in many applications as medium-voltage insulation, although they are prone to deformation at high temperatures. However, polyethylene homopolymers are very prone to water treeing, especially toward the upper end of the medium-voltage range.

There have been attempts to make polyethylene-based polymers that would have long-term electrical stability. For example, when dicumyl peroxide is used as a crosslinking agent for polyethylene, the peroxide residue functions as a tree inhibitor for some time after curing. However, these residues are eventually lost at most temperatures where electrical power cable is used. U.S. Pat. No. 4,144,202 issued Mar. 13, 1979 to Ashcraft, et al. discloses the incorporation into polyethylenes of at least one epoxy containing organo-silane as a treeing inhibitor. However, a need still exists for a polymeric insulator having improved treeing resistance over such silane containing polyethylenes.

Unlike polyethylene, which can be utilized neat, the other common medium-voltage insulator, EPR, typically contains a high level of filler in order to resist treeing. When utilized as a medium-voltage insulator, EPR will generally contain about 20 to about 50 weight percent filler, most likely calcined clay, and is preferably crosslinked with peroxides. The presence of the filler gives EPR a high resistance against the propagation of trees. EPR also has mechanical properties, which are superior to polyethylene at elevated temperatures. EPR is also much more flexible than polyethylene which can be an advantage for tight space or difficult installation.

Unfortunately, while the fillers utilized in EPR may help prevent treeing, the filled EPR will generally have poor dielectric properties, i.e. a poor dielectric constant and a poor power factor. The dielectric constant of filled EPR is in the range of about 2.3 to about 2.8. Its power factor is on the order of about 0.002 to about 0.005 at room temperature, which is approximately an order of magnitude worse than polyethylene.

Thus, both polyethylenes and EPR have serious limitations as an electrical insulator in cable applications. Although polyethylene polymers have good electric properties, they have poor water tree resistance. While filled EPR has good treeing resistance and good mechanical properties, it has dielectric properties inferior to polyethylene polymers.

Hindered amine light stabilizers or “HAL”s are primarily used in clear plastic film, sheets or coatings to prevent degradation by light. HALs are used in unfilled polyethylene insulations. They are thought to prevent degradation caused by light emitted by tiny electrical discharges. U.S. Pat. No. 5,719,218 discloses an optically transparent polyethylene insulation formulation with a HALs where it is stated that the HALs are useful for the prevention of degradation of the insulation by water trees.

The use of antioxidant combinations is possible, but only a few of these combinations can meet the desired combination of properties that are required for an insulating material for medium voltage and high voltage power cable comprising, good anti-scorch, limited interaction with the peroxide during cross-linking, good long term stability, good solubility, a low melting point, and good color.

Previous inventions have also used styrene copolymers to effect performance of cable performance. Examples of which are U.S. Pat. Nos. 4,876,147; 5,180,889; 6,242,097; 6,509,527; and U.S. Patent Application Publication No. 2009/0321108. Those compositions, however, uses complicated polymer systems, and/or high content of expensive styrene copolymer.

Therefore, a need exists in the electrical cable industry for a polyolefin insulation system that provide improved cable performance.

### SUMMARY OF THE INVENTION

The invention provides an insulation composition for electric cable containing (a) a polyolefin; and (b) a styrene copolymer. The styrene copolymer either 1) has a styrene content of 55 percent (by weight base on the total styrene copolymer) or greater; 2) contains a random arrangement of styrene and at least one other block polymer; and/or 3) contains a triblock having pure styrene at the two ends of the triblock and alkylene-styrene as the center block. The composition can also contain antioxidants, stabilizers, fillers, peroxide, etc. In preferred embodiments, the styrene copolymer is present at 5 percent (by weight base on the total polymer) or less. The preferred polyolefin is polyethylene. Preferably, the insulation composition is crosslinked.

The invention also provides an electric cable containing an electrical conductor surrounded by an insulation. The insulation contains (a) a polyolefin; and (b) a styrene copolymer; where the styrene copolymer either 1) has a styrene content of 55 percent (by weight base on the total styrene copolymer) or greater; 2) contains random arrangement of styrene, propylene, and ethylene; and/or 3) contains a triblock having polystyrene at the two ends of the triblock and poly(ethylene-butylene-styrene) as the center block. The cable can also contain at least one shield layer and jacket as known in the art.

The invention also provides method of making a polymer containing a polyolefin and a styrene copolymer.

### DETAIL DESCRIPTION OF THE PREFERRED EMBODIMENTS

The invention provides an insulation composition for electric cable containing (a) a polyolefin; and (b) a styrene copolymer. The styrene copolymer either 1) has a styrene content of 55 percent (by weight base on the total styrene copolymer) or greater; 2) contains random arrangement of styrene, propylene, and ethylene; and/or 3) contains a triblock having pure styrene at the two ends of the triblock and alkylene-styrene as the center block.

Polyolefins, as used herein, are polymers produced from alkenes having the general formula CₙH₂ₙ. In embodiments of the invention the polyolefin is prepared using a conventional Ziegler-Natta catalyst. In preferred embodiments of the invention the polyolefin is selected from the group consisting of a Ziegler-Natta polyethylene, a Ziegler-Natta polypropylene, a copolymer of Ziegler-Natta polyethylene and Ziegler-Natta polypropylene, and a mixture of Ziegler-Natta polyethylene and Ziegler-Natta polypropylene. In more preferred embodiments of the invention the polyolefin is a Ziegler-Natta low density polyethylene (LDPE) or a Ziegler-Natta linear low density polyethylene (LLDPE) or a combination of a Ziegler-Natta LDPE and a Ziegler-Natta LLDPE.

In other embodiments of the invention the polyolefin is prepared using a metallocene catalyst. Alternatively, the polyolefin is a mixture or blend of Ziegler-Natta and metallocene polymers.

The polyolefins utilized in the insulation composition for electric cable in accordance with the invention may also be selected from the group of polymers consisting of ethylene polymerized with at least one co-monomer selected from the group consisting of C₃ to C₂₀ alpha-olefins and C₃ to C₂₀ polyenes. Generally, the alpha-olefins suitable for use in the invention contain in the range of about 3 to about 20 carbon atoms. Preferably, the alpha-olefins contain in the range of about 3 to about 16 carbon atoms, most preferably in the range of about 3 to about 8 carbon atoms. Illustrative non-limiting examples of such alpha-olefins are propylene, 1-butene, 1-pentene, 1-hexene, 1-octene and 1-dodecene.

The polyolefins utilized in the insulation composition for electric cables in accordance with the invention may also be selected from the group of polymers consisting of either ethylene/alpha-olefin copolymers or ethylene/alpha-olefin/diene terpolymers. The polyene utilized in the invention generally has about 3 to about 20 carbon atoms. Preferably, the polyene has in the range of about 4 to about 20 carbon atoms, most preferably in the range of about 4 to about 15 carbon atoms. Preferably, the polyene is a diene, which can be a straight chain, branched chain, or cyclic hydrocarbon diene. Most preferably, the diene is a non conjugated diene. Examples of suitable dienes are straight chain acyclic dienes such as: 1,3-butadiene, 1,4-hexadiene and 1,6-octadiene; branched chain acyclic dienes such as: 5-methyl-1,4-hexadiene, 3,7-dimethyl-1,6-octadiene, 3,7-dimethyl-1,7-octadiene and mixed isomers of dihydro myricene and dihydroocinene; single ring alicyclic dienes such as: 1,3-cyclopentadiene, 1,4-cylcohexadiene, 1,5-cyclooctadiene and 1,5-cyclododecadiene; and multi-ring alicyclic fused and bridged ring dienes such as: tetrahydroindene, methyl tetrahydroindene, dicylcopentadiene, bicyclo-(2,2,1)-hepta-2-5-diene; alkenyl, alkylidene, cycloalkenyl and cycloalkylidene norbornenes such as 5-methylene-2morbornene (MNB), 5-propenyl-2-norbornene, 5-isopropylidene-2-norbornene, 5-(4-cyclopentenyl)-2-norbornene, 5-cyclohexylidene-2-norbornene, 5-vinyl-2-norbornene and norbornene. Of the dienes typically used to prepare EPR's, the particularly preferred dienes are 1,4-hexadiene, 5-ethylidene-2-norbornene, 5-vinyllidene-2-norbornene, 5-methylene-2-norbornene and dicyclopentadiene. The especially preferred dienes are 5-ethylidene-2-norbornene and 1,4-hexadiene.

As an additional polymer in the polyolefin composition, a non-metallocene polyolefin may be used having the structural formula of any of the polyolefins or polyolefin copolymers described above. Ethylene-propylene rubber (EPR), polyethylene, polypropylene may all be used in combination with the Zeigler Natta and/or metallocene polymers.

In embodiments of the invention, the polyolefin contains 30% to 50% by weight Zeigler Natta polymer or polymers and 50% to 70% by weight metallocene polymer or polymers The total amount of additives in the treeing resistant “additive package” are from about 0.5% to about 4.0% by weight of said composition, preferably from about 1.0% to about 2.5% by weight of said composition.

A number of catalysts have been found for the polymerization of olefins. Some of the earliest catalysts of this type resulted from the combination of certain transition metal compounds with organometallic compounds of Groups I, II, and III of the Periodic Table. Due to the extensive amounts of early work done by certain research groups many of the catalysts of that type came to be referred to by those skilled in the area as Ziegler-Natta type catalysts. The most commercially successful of the so-called Ziegler-Natta catalysts have heretofore generally been those employing a combination of a transition metal compound and an organoaluminum compound.

Metallocene polymers are produced using a class of highly active olefin catalysts known as metallocenes, which for the purposes of this application are generally defined to contain one or more cyclopentadienyl moiety. The manufacture of metallocene polymers is described in U.S. Pat. No. 6,270,856 to Hendewerk, et al, the disclosure of which is incorporated by reference in its entirety.

Metallocenes are well known especially in the preparation of polyethylene and copolyethylene-alpha-olefins. These catalysts, particularly those based on group IV transition metals, zirconium, titanium and hafnium, show extremely high activity in ethylene polymerization. Various forms of the catalyst system of the metallocene type may be used for polymerization to prepare the polymers used in this invention, including but not limited to those of the homogeneous, supported catalyst type, wherein the catalyst and cocatalyst are together supported or reacted together onto an inert support for polymerization by a gas phase process, high pressure process, or a slurry, solution polymerization process. The metallocene catalysts are also highly flexible in that, by manipulation of the catalyst composition and reaction conditions, they can be made to provide polyolefins with controllable molecular weights from as low as about 200 (useful in applications such as lube-oil additives) to about 1 million or higher, as for example in ultra-high molecular weight linear polyethylene. At the same time, the MWD of the polymers can be controlled from extremely narrow (as in a polydispersity of about 2), to broad (as in a polydispersity of about 8).

Exemplary of the development of these metallocene catalysts for the polymerization of ethylene are U.S. Pat. No. 4,937,299 and EP-A-0 129 368 to Ewen, et al., U.S. Pat. No. 4,808,561 to Welborn, Jr., and U.S. Pat. No. 4,814,310 to Chang, which are all hereby are fully incorporated by reference. Among other things, Ewen, et al. teaches that the structure of the metallocene catalyst includes an alumoxane, formed when water reacts with trialkyl aluminum. The alumoxane complexes with the metallocene compound to form the catalyst. Welborn, Jr. teaches a method of polymerization of ethylene with alpha-olefins and/or diolefins. Chang teaches a method of making a metallocene alumoxane catalyst system utilizing the absorbed water in a silica gel catalyst support. Specific methods for making ethylene/alpha-olefin copolymers, and ethylene/alpha-olefin/diene terpolymers are taught in U.S. Pat. Nos. 4,871,705 (issued Oct. 3, 1989) and 5,001,205 (issued Mar. 19, 1991) to Hoel, et al., and in EP-A-0 347 129 published Apr. 8, 1992, respectively, all of which are hereby fully incorporated by reference.

The preferred polyolefins are polyethylene, polybutylene, ethylene-vinyl-acetate, ethylene-propylene copolymer, and other ethylene-α olefin copolymers.

The styrene copolymer used in the present composition 1) has a styrene content of 55 percent (by weight base on the total styrene copolymer) or greater; 2) contains a random arrangement of styrene and at least one other block polymer; and/or 3) contains a triblock having styrene at the two ends of the triblock and alkylene-styrene as the center block.

In an embodiment, the styrene content of the copolymer is at least 55 percent (by weight of the total styrene copolymer), preferably at least 60 percent. In that embodiment, the styrene copolymer can be any available styrene copolymer as long as the high percentage of styrene content is met. The styrene copolymer can include, for example, an SE block copolymer made from styrene and ethylene, an SB block copolymer made from styrene (S) and butadiene (B), an SEB block copolymer made by saturating the unsaturated double bonds in the above butadiene block by hydrogenation, and an SEP block copolymer made from styrene (S) and ethylene/propylene (EP). Other styrene copolymers include a tri-block with styrene at the ends of the tri-block, such as SES, SEBS, SBS, and SEPS. The preferred styrene copolymer for this embodiment is SEBS, SEPS, SBS, and/or SE.

In another embodiment, the styrene copolymer contains a random arrangement of styrene and at least one other block polymer which can be, but is not limited to, ethylene, butylene, propylene and isoprene. In a preferred embodiment, the styrene copolymer is a random arrangement of styrene and ethylene.

In yet another embodiment, the styrene copolymer is a triblock having the general formula S-AS-S, where S is styrene and A is an alkylene or mixture of different alkylenes. In this embodiment, the two end blocks are pure styrene while the middle block is a styrene copolymer. The alkylene or mixture of different alkylenes can be, but is not limited to ethylene (E), butylene (B), ethylene/butylene (EB), and/or ethylene/propylene (EP). The preferred triblock copolymer has the general formula S-BES-S, where the two end blocks are pure styrene and the middle block is butylene/ethylene/styrene.

It is preferred that the composition of the present invention contains the styrene copolymer at about 5 percent by weight of the total polymer or less, more preferably 2.5 percent or less. The total polymer, as used herein, include the polyolefin and the styrene copolymer.

The polymer of the present invention is preferably crosslinked to form a durable insulation material. Preferably, the polyolefins is crosslinked. The styrenic copolymer may also crosslinked with itself or with the polyolefins. Crosslinking can be accomplished using methods known in the art, including, but not limited to, irradiation, chemical or steam curing, and saline curing. The crosslinking can be accomplished by direct carbon-carbon bond between adjacent polymers or by a linking group.

The insulation compositions may optionally be blended with various additives that are generally used in insulted wires or cables, such as an antioxidant, a metal deactivator, a flame retarder, a dispersant, a colorant, a filler, a stabilizer, a peroxide, and/or a lubricant, in the ranges where the object of the present invention is not impaired. The additives should be less than about 5 percent (by weight base on the total polymer), preferably less than about 3 percent, more preferably less than about 0.6 percent.

The antioxidant, can include, for example, amine-antioxidants, such as 4,4′-dioctyl diphenylamine, N,N′-diphenyl-p-phenylenediamine, and polymers of 2,2,4-trimethyl-1,2-dihydroquinoline; phenolic antioxidants, such as thiodiethylene bis[3-(3,5-di-tert-butyl-4-hydroxyphenyl)propionate], 4,4′-thiobis(2-tert-butyl-5-methylphenol), 2,2′-thiobis(4-methyl-6-tert-butyl-phenol), benzenepropanoic acid, 3,5 bis(1,1 dimethylethyl)-4-hydroxy benzenepropanoic acid, 3,5-bis(1,1-dimethylethyl)-4-hydroxy-C13-15 branched and linear alkyl esters, 3,5-di-tert-butyl-4-hydroxyhydrocinnamic acid C₇₋₉-Branched alkyl ester, 2,4-dimethyl-6-t-butylphenol Tetrakis{methylene3-(3′,5′-ditert-butyl-4′-hydroxyphenol)propionate}metha-ne or Tetrakis{methylene3-(3′,5′-ditert-butyl-4′-hydrocinnamate}methane, 1,1,3-tris(2-methyl-4-hydroxyl5butylphenyl)butane, 2,5,di t-amyl hydroqunone, 1,3,5-trimethyl-2,4,6-tris(3,5-di tert butyl-4-hydroxybenzyl)benzene, 1,3,5-tris(3,5-di tert butyl-4-hydroxybenzyl)isocyanurate, 2,2-Methylene-bis-(4-methyl-6-tert butyl-phenol), 6,6′-di-tert-butyl-2,2′-thiodi-p-cresol or 2,2′-thiobis(4-methyl-6-tert-butylphenol), 2,2-ethylenebis(4,6-di-t-butylphenol), triethyleneglycol bis{3-(3-t-butyl-4-hydroxy-5-methylphenyl)propionate}, 1,3,5-tris(4-tert butyl3hydroxy-2,6-dimethylbenzyl)-1,3,5-triazine-2,4,6-(1H,3H,5H)trione, 2,2-methylenebis{6-(1-methylcyclohexyl)-p-cresol}; and/or sulfur antioxidants, such as bis(2-methyl-4-(3-n-alkylthiopropionyloxy)-5-t-butylphenyl)sulfide, 2-mercaptobenzimidazole and its zinc salts, and pentaerythritol-tetrakis(3-lauryl-thiopropionate). The preferred antioxidant is thiodiethylene bis[3-[3,5-di-tert-butyl-4-hydroxyphenyl]propionate which is available commercially as Irganox® 1035.

The metal deactivator, can include, for example, N,N′-bis(3-(3,5-di-t-butyl-4-hydroxyphenyl)propionyl)hydrazine, 3-(N-salicyloyl)amino-1,2,4-triazole, and/or 2,2′-oxamidobis-(ethyl 3-(3,5-di-t-butyl-4-hydroxyphenyl)propionate).

The flame retarder, can include, for example, halogen flame retarders, such as tetrabromobisphenol A (TBA), decabromodiphenyl oxide (DBDPO), octabromodiphenyl ether (OBDPE), hexabromocyclododecane (HBCD), bistribromophenoxyethane (BTBPE), tribromophenol (TBP), ethylenebistetrabromophthalimide, TBA/polycarbonate oligomers, brominated polystyrenes, brominated epoxys, ethylenebispentabromodiphenyl, chlorinated paraffins, and dodecachlorocyclooctane; inorganic flame retarders, such as aluminum hydroxide and magnesium hydroxide; and/or phosphorus flame retarders, such as phosphoric acid compounds, polyphosphoric acid compounds, and red phosphorus compounds.

The filler, can be, for example, carbons, clays, zinc oxide, tin oxides, magnesium oxide, molybdenum oxides, antimony trioxide, silica, talc, potassium carbonate, magnesium carbonate, and/or zinc borate.

The stabilizer, can be, but is not limited to, hindered amine light stabilizers (HALS) and/or heat stabilizers. The HALS can include, for example, bis(2,2,6,6-tetramethyl-4-piperidyl)sebaceate (Tinuvin® 770); bis(1,2,2,6,6-tetramethyl-4-piperidyl)sebaceate+methyl1,2,2,6,6-tetrameth-yl-4-piperidyl sebaceate (Tinuvin® 765); 1,6-Hexanediamine, N,N′-Bis(2,2,6,6-tetramethyl-4-piperidyl)polymer with 2,4,6 trichloro-1,3,5-triazine, reaction products with N-butyl-2,2,6,6-tetramethyl-4-piperidinamine (Chimassorb® 2020); decanedioic acid, Bis(2,2,6,6-tetramethyl-1-(octyloxy)-4-piperidyl)ester, reaction products with 1,1-dimethylethylhydroperoxide and octane (Tinuvin® 123); triazine derivatives (Tinuvin® NOR 371); butanedioc acid, dimethylester, polymer with 4-hydroxy-2,2,6,6-tetramethyl-1-piperidine ethanol (Tinuvin® 622); 1,3,5-triazine-2,4,6-triamine,N,N′″-[1,2-ethane-diyl-bis[[[4,6-bis-1-[butyl(1,2,2,6,6-pentamethyl-4-piperidinyl)amino]-1,3,5-triazine-2-yl]imino-]-3,1-propanediyl]]bis[N′,N″-dibutyl-N′,N″bis(2,2,6,6-tetramethyl-4-pipe-ridyl) (Chimassorb® 119); and/or bis(1,2,2,6,6-pentamethyl-4-piperidinyl)sebacate (Songlight® 2920); poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]] (Chimassorb® 944); Benzenepropanoic acid, 3,5-bis(1,1-dimethyl-ethyl)-4-hydroxy-.C7-C9 branched alkyl esters (Irganox® 1135); and/or Isotridecyl-3-(3,5-di-tert-butyl-4-hydroxyphenyl)propionate (Songnox® 1077 LQ). The preferred HALS is bis(1,2,2,6,6-pentamethyl-4-piperidinyl)sebacate commercially available as Songlight 2920.

The heat stabilizer can be, but is not limited to, 4,6-bis(octylthiomethyl)-o-cresol (Irgastab KV-10); dioctadecyl 3,3′-thiodipropionate (Irganox PS802); poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]] (Chimassorb® 944); Benzenepropanoic acid, 3,5-bis(1,1-dimethyl-ethyl)-4-hydroxy-.C7-C9 branched alkyl esters (Irganox® 1135); Isotridecyl-3-(3,5-di-tert-butyl-4-hydroxyphenyl)propionate (Songnox® 1077 LQ). If used, the preferred heat stabilizer is 4,6-bis(octylthiomethyl)-o-cresol (Irgastab KV-10); dioctadecyl 3,3′-thiodipropionate (Irganox PS802) and/or poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]] (Chimassorb® 944).

The compositions of the invention can be prepared by blending the base polyolefin polymer, styrene copolymer, and additives by use of conventional masticating equipment, for example, a rubber mill, Brabender Mixer, Banbury Mixer, Buss-Ko Kneader, Farrel continuous mixer or twin screw continuous mixer. The additives are preferably premixed before addition to the base polyolefin polymer. Mixing times should be sufficient to obtain homogeneous blends. All of the components of the compositions utilized in the invention are usually blended or compounded together prior to their introduction into an extrusion device from which they are to be extruded onto an electrical conductor.

After the various components of the composition are uniformly admixed and blended together, they are further processed to fabricate the cables of the invention. Prior art methods for fabricating polymer cable insulation or cable jacket are well known, and fabrication of the cable of the invention may generally be accomplished by any of the various extrusion methods.

In a typical extrusion method, an optionally heated conducting core to be coated is pulled through a heated extrusion die, generally a cross-head die, in which a layer of melted polymer is applied to the conducting core. Upon exiting the die, if the polymer is adapted as a thermoset composition, the conducting core with the applied polymer layer may be passed through a heated vulcanizing section, or continuous vulcanizing section and then a cooling section, generally an elongated cooling bath, to cool. Multiple polymer layers may be applied by consecutive extrusion steps in which an additional layer is added in each step, or with the proper type of die, multiple polymer layers may be applied simultaneously.

The conductor of the invention may generally comprise any suitable electrically conducting material, although generally electrically conducting metals are utilized. Preferably, the metals utilized are copper or aluminum. In power transmission, aluminum conductor/steel reinforcement (ACSR) cable, aluminum conductor/aluminum reinforcement (ACAR) cable, or aluminum cable is generally preferred.

Without further description, it is believed that one of ordinary skill in the art can, using the preceding description and the following illustrative example, make and utilize the compounds of the present invention and practice the claimed methods. The following example is given to illustrate the present invention. It should be understood that the invention is not to be limited to the specific conditions or details described in this example.

### Example 1

Square 14 gauge copper conductor wires with 30 mils of insulation were extruded with a 20:1 LD Davis standard extruder and a crosshead die and cured in steam at 400° F. 25 inch samples (n=20) of these insulated square conductor wires were placed in a 75° C. water bath and energized with 7500 volts. Time to short circuit was recorded.

The purpose of the square conductor is to create an electrical stress concentration at each corner and accelerate time to failure.

Table 1 shows properties of the styrene copolymers being tested:

TABLE 1

| | | | | Hardness | % | |
|---|---|---|---|---|---|---|
| Supplier | Grade | Structure | % Styrene | (Shore) | Diblock | % Oil |
| Kraton | D1102K | Clear SBS | 38.5 | 66 | 17 | |
| | G1641H | SEBS | 33 | 52 | <1 | |
| | G1643M | SEBS | 20 | 52 | | |
| | G1650M | SEBS | 30 | 72 | <1 | |
| | G1651H | SEBS | 33 | 60 | <1 | |
| | G1657M | SEBS | 13 | 47 | 29 | |
| | G1702H | SEP linear | 28 | 41 | 100 | |
| | MD6945M | SEBS | 14 | 35 | | |
| | RP6935 | S(EBS)S | 54.6-60.4 | 83 | | |
| | RP6936 | S(EBS)S | 42 | 68 | | |
| | MD1537 | S(EBS)S | 57-63 | 78 | | |
| | Oil | S(EBS)S | 45.6-50.4 | | | 20 |
| | Extended | | | | | |
| | MD1537 | | | | | |
| | Oil | S(EBS)S | 43.7-48.3 | | | 20 |
| | Extended | | | | | |
| | RP6935 | | | | | |
| Asahi | SS9000 | Random | 39 | 80 | | |
| Kasei | | SE | | | | |
| | H1043 | SEBS | 67 | 72 | | |

Tables 2-4 shows the square wire test result for the compositions shown:

TABLE 2

| | Compositions | | | | | | | | | | | |
|---|---|---|---|---|---|---|---|---|---|---|---|---|
| Components | 1 | 2 | 3 | 4 | 5 | 6 | 7 | 8 | 9 | 10 | 11 | 12 |
| LDPE | 99.6 | 94.6 | 94.6 | 94.6 | 94.6 | 94.6 | 94.6 | 94.6 | 94.6 | 94.6 | 94.6 | 94.6 |
| D1102K | | 5 | | | | | | | | | | |
| G1641 | | | 5 | | | | | | | | | |
| G1643M | | | | 5 | | | | | | | | |
| G1650M | | | | | 5 | | | | | | | |
| G1657M | | | | | | 5 | | | | | | |
| G1702H | | | | | | | 5 | | | | | |
| MD6945 | | | | | | | | 5 | | | | |
| RP6935 | | | | | | | | | 5 | | | |
| PR6936 | | | | | | | | | | 5 | | |
| SS9000 | | | | | | | | | | | 5 | |
| G1651H | | | | | | | | | | | | 5 |
| Irganox PS802 | 0.2 | 0.2 | 0.2 | 0.2 | 0.2 | 0.2 | 0.2 | 0.2 | 0.2 | 0.2 | 0.2 | 0.2 |
| Irganox 1035 | 0.2 | 0.2 | 0.2 | 0.2 | 0.2 | 0.2 | 0.2 | 0.2 | 0.2 | 0.2 | 0.2 | 0.2 |
| Songlight 2920 | | | | | | | | | | | | |
| Irgastab KV-10 | | | | | | | | | | | | |
| Dicup | 1.8 | 1.8 | 1.8 | 1.8 | 1.8 | 1.8 | 1.8 | 1.8 | 1.8 | 1.8 | 1.8 | 1.8 |
| Luperox D-16 | | | | | | | | | | | | |

Square wire test results (WK#559)

| | | | | | | | | | | | | |
|---|---|---|---|---|---|---|---|---|---|---|---|---|
| Weibull Mean | 214 | 224 | 365 | 370 | 284 | 246 | 304 | 303 | 485 | 246 | 275 | 255 |
| value, hours | | | | | | | | | | | | |
| Weibull Beta value | 11.27 | 6.96 | 3.30 | 4.31 | 3.84 | 5.04 | 4.07 | 7.18 | 11.06 | 7.57 | 6.85 | 10.01 |
| Square wire | 26.44 | 24.56 | 28.34 | 30.70 | 29.23 | 25.33 | 24.00 | 29.68 | 30.63 | 30.13 | 25.61 | 25.85 |
| breakdown | | | | | | | | | | | | |
| strength, KV | | | | | | | | | | | | |

TABLE 3

| | Compositions | | | | | | | | | | |
|---|---|---|---|---|---|---|---|---|---|---|---|
| Components | 13 | 14 | 15 | 16 | 17 | 18 | 19 | 20 | 21 | 22 | 23 |
| LDPE | 97.2 | 97 | 94.7 | 97.2 | 97 | 94.7 | 97 | 94.7 | 97.2 | 97 | 94.7 |
| MD1537 | 2.5 | 2.5 | 5 | 2.5 | 2.5 | 5 | | | | | |
| Oil Extended 1537 | | | | | | | 2.5 | 5 | | | |
| Oil Extended RP6935 | | | | | | | | | 2.5 | 2.5 | 5 |
| Songlight 2920 | | 0.2 | | | 0.2 | | 0.2 | | | 0.2 | |
| Irgastab KV-10 | 0.3 | 0.3 | 0.3 | 0.3 | 0.3 | 0.3 | 0.3 | 0.3 | 0.3 | 0.3 | 0.3 |
| Dicup | | | | | | | | | | | |
| Luperox D-16 | 1.8 | 1.8 | 1.8 | 1.8 | 1.8 | 1.8 | 1.8 | 1.8 | 1.8 | 1.8 | 1.8 |

Square wire test results (WK#598)

| | | | | | | | | | | | |
|---|---|---|---|---|---|---|---|---|---|---|---|
| Weibull Mean value, | 278 | 680 | 347 | 343 | 322 | 448 | 577 | 408 | 199 | 338 | 343 |
| hours | | | | | | | | | | | |
| Weibull Beta value | 4.40 | 3.65 | 7.80 | 4.40 | 4.90 | 2.87 | 6.82 | 4.92 | 2.20 | 3.80 | 2.73 |
| Square wire | 30.06 | 29.26 | 23.82 | 28.46 | 20.43 | 21.40 | 28.00 | 20.36 | 23.30 | 22.11 | 22.75 |
| breakdown strength, | | | | | | | | | | | |
| KV | | | | | | | | | | | |

TABLE 4

| | |
|---|---|
| Components | Compositions |

| Raw Materials | 24 | 25 | 26 | 27 |
|---|---|---|---|---|
| LDPE | 97.2 | 97.0 | 97.2 | 97.0 |
| SS9000 | 2.5 | 2.5 | | |
| Tuftec H1043 | | | 2.5 | 2.5 |
| Songlight 2920 | | 0.2 | | 0.2 |
| Irgastab KV-10 | 0.3 | 0.3 | 0.3 | 0.3 |
| Dicup | | | | |
| Luperox D-16 | 1.8 | 1.8 | 1.8 | 1.8 |

Square wire test results (WK#611)

| | | | | |
|---|---|---|---|---|
| Weibull Mean | 910 | 1192* | 801 | 1404 |
| value, hours | | | | |
| Weibull Beta | 9.30 | 9.30 | 3.65 | 2.24 |
| value | | | | |
| Square wire | 31.22 | 30.67 | 25.12 | 28.86 |
| breakdown | | | | |
| strength, KV | | | | |

*Projected value

### Example 2

1/0 AWG 175 mil wall cables were made with insulations having the composition shown in Table 5.

TABLE 5

| | Compositions | | |
|---|---|---|---|
| Components | 28 | 29 | 30 |
| LDPE | 99.2 | 99.2 | 99.2 |
| S.O.E. L605* | 1 | | |
| Tuftec | | 1 | |
| H1043** | | | |
| Kraton | | | 1 |
| MD1537 | | | |
| Irganox 1035 | 0.25 | 0.25 | 0.25 |
| Irganox PS802 | 0.25 | 0.25 | 0.25 |
| Tunivin 622 LD | 0.2 | 0.2 | 0.2 |
| Lowinox TBP6 | 0.1 | 0.1 | 0.1 |
| Luperox D-16 | 1.5 | 1.5 | 1.5 |

*S.O.E. L605 = Hydrogenated styrene butadiene copolymer
**Turftec H1043 = Styrene ethylene butylene styrene (SEBS) block copolymer; 67% by weight styrene; hardness (Shore)-72.

Tables 6-8 show the dissipation factor for each of the cable made in accordance to part 10.5.5.4 Electrical Measurements of ICEA S-94-649-2004.

TABLE 6
Composition 28

| | | | | ICEA MAx XLPE/ |
|---|---|---|---|---|
| Week | Ambient (%) | 105° C. (%) | 140° C. (%) | TRXLPE (%) |
| 0 | 0.094 | 0.056 | 0.07 | 0.5 |
| 1 | 0.023 | 0.034 | 0.06 | 0.5 |
| 2 | 0.024 | 0.088 | 0.08 | 0.5 |
| 3 | 0.025 | 0.184 | 0.237 | 0.5 |
| 4 | 0.032 | 0.195 | 0.248 | 0.5 |
| 5 | 0.028 | 0.187 | 0.239 | 0.5 |
| 6 | 0.036 | 0.182 | 0.244 | 0.5 |

TABLE 7
Composition 29

| | | | | ICEA MAx XLPE/ |
|---|---|---|---|---|
| Week | Ambient (%) | 105° C. (%) | 140° C. (%) | TRXLPE (%) |
| 0 | 0.068 | 0.012 | 0.05 | 0.5 |
| 1 | 0.017 | 0.025 | 0.062 | 0.5 |
| 2 | 0.018 | 0.087 | 0.074 | 0.5 |
| 3 | 0.019 | 0.187 | 0.243 | 0.5 |
| 4 | 0.027 | 0.195 | 0.249 | 0.5 |
| 5 | 0.024 | 0.198 | 0.261 | 0.5 |
| 6 | 0.04 | 0.187 | 0.243 | 0.5 |

TABLE 8
Composition 30

| | | | | ICEA MAx XLPE/ |
|---|---|---|---|---|
| Week | Ambient (%) | 105° C. (%) | 140° C. (%) | TRXLPE (%) |
| 0 | 0.088 | 0.019 | 0.158 | 0.5 |
| 1 | 0.016 | 0.031 | 0.067 | 0.5 |
| 2 | 0.017 | 0.117 | 0.12 | 0.5 |
| 3 | 0.018 | 0.213 | 0.275 | 0.5 |
| 4 | 0.027 | 0.199 | 0.293 | 0.5 |
| 5 | 0.032 | 0.194 | 0.263 | 0.5 |
| 6 | 0.071 | 0.186 | 0.277 | 0.5 |

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A composition comprising a polyolefin polymer and a styrene copolymer, wherein the styrene copolymer contains either
a. a styrene content of 55 percent (by weight base on the total styrene copolymer) or greater;
b. a random arrangement of styrene and at least one other block polymer; and/or
c. a triblock having the formula S-AS-S, wherein S is styrene and A is alkylene or a mixture of different alkylenes.

2. The composition of claim 1, further comprising at least one additive.

3. The composition of claim 2, wherein the at least one additive is selected from the group consisting of an antioxidant, a metal deactivator, a flame retarder, a dispersant, a colorant, a filler, a stabilizer, a peroxide, and a lubricant.

4. The composition of claim 1, wherein the antioxidant is thiodiethylene bis[3-[3,5-di-tert-butyl-4-hydroxyphenyl]propionate.

5. The composition of claim 1, wherein the stabilizer is bis(1,2,2,6,6-pentamethyl-4-piperidinyl)sebacate, 4,6-bis(octylthiomethyl)-o-cresol, or dioctadecyl 3,3′-thiodipropionate.

6. The composition of claim 1, wherein the styrene copolymer is present at about 5 percent by weight of total polymer or less.

7. The composition of claim 1, wherein A is ethylene-butylene.

8. The composition of claim 1, wherein b is a random arrangement of styrene-ethylene.

9. The composition of claim 1, wherein polymers are crosslinked.

10. A cable comprising a conductor and a covering made of the material of claim 1.

11. The cable of claim 10, wherein the covering is an insulation or a jacket.

12. The cable of claim 10, further comprising at least one additive.

13. The cable of claim 12, wherein the at least one additive is selected from the group consisting of an antioxidant, a metal deactivator, a flame retarder, a dispersant, a colorant, a filler, a stabilizer, a peroxide, and a lubricant.

14. The cable of claim 10, wherein the antioxidant is thiodiethylene bis[3-[3,5-di-tert-butyl-4-hydroxyphenyl]propionate.

15. The cable of claim 10, wherein the stabilizer is bis(1,2,2,6,6-pentamethyl-4-piperidinyl)sebacate, 4,6-bis(octylthiomethyl)-o-cresol, or dioctadecyl 3,3′-thiodipropionate.

16. The cable of claim 10, wherein the styrene copolymer is present at about 5 percent by weight of total polymer or less.

17. The cable of claim 10, wherein A is ethylene-butylene.

18. The cable of claim 10, wherein b is a random arrangement of styrene-ethylene.

19. A method for making a cable comprising the step of
a. providing a conductor; and
b. covering the conductor with the material of claim 1.

20. The method of claim 19, wherein step b is used to make an insulation or a jacket.
